(19) United States
(12) Patent Application Publication
(10) Pub. No.: US 2023/0391648 A1
(43) Pub. Date: Dec. 7, 2023

(54) Method and A Process to Remove Inorganic and Organic Substances from Water

(71) Applicant: Muslim Dwight Shahid, Spring, TX (US)

(72) Inventor: Muslim Dwight Shahid, Spring, TX (US)

(73) Assignee: Muslim D Shahid, Spring, TX (US)

(21) Appl. No.: 17/833,236

(22) Filed: Jun. 6, 2022

Related U.S. Application Data
(60) Provisional application No. 63/258,942, filed on Jun. 7, 2021.

(51) Int. Cl. C02F 9/00

(52) U.S. Cl. CPC C02F 9/00; C02F 1/004

(57) ABSTRACT

An apparatus that comprises a method and a process that is a network of functional systems to remove harmful inorganic and organic substances present in natural or man-made water sources and industrial processes wherein said apparatus is a water purification device.

### BACKGROUND

Transition and Post-Transition metal presence in public municipality drinking water resources represents continuing challenges for county, state, and federal agencies as they attempt to develop better methods and procedures for the removal of such toxins to ensure the health and safety of the general public. Heavy metals such as mercury, lead, cobalt, cadmium, vanadium, chromium, and arsenic have all been found to be present in industrial wastewater discharge and in some cases even public drinking water reservoirs often time at levels that have been determined to be significantly dangerous to health of the public. Even common biological important metals such as iron and copper could be dangerous to aquatic life and some mammalian organisms if found in high enough concentrations levels in the environment. Furthermore, organic pollutants from energy producers, chemical manufacturers, polyfluoroalkyl substances from plastic waste disposal, and agricultural industries have also been found in public drinking water resources.

### FIELD OF THE INVENTION

The present invention is directed to a method and a process that comprises an apparatus that is designed to remove harmful inorganic arlorganic substances from water sources (oceans, ponds, lakes, rivers, etc.) The present invention utilizes a precipitation-centrifugation-filtration-purification mind and process to make water safe for human consumption or as desirable discharge effluents back into the natural environment.

### DESCRIPTION OF THE RELATED ART

Many water treating systems used by municipal and industrial wastewater producers in have constant challenges of meeting most of the EPA limits set for heavy metals such as lead, mercury, vanadium, and iron levels for drinking water consumed by public communities. Most water treating systems rely on filtration and/or reverse osmosis technology to purify water resources or discharge. U.S. Pat. No. 7,361,280,B2, 5,444,031, 5,344,566A, 5,071,587A and applications, 142,694,99P, and 2,018,028,484 all describe the use of natural zealots, sand, or adsorption materials like carbon and activated carbon substances for the removal of heavy metals and organics from water. However, current research publications in the area of water treatment clearly shows that in many municipalities higher than desirable levels of lead, arsenic, chromium, and even iron can be found in many public drinking water resources. Even more so, in some municipalities the drinking water supply in the US still contain high levels lead, exceeding EPA action levels.

U.S. Pat. Nos. 4,332,350, 4,990,237, 5,149,424A, and 6,132,630A all teach the use of centrifugation to remove organic fluids, oils, and solids from wastewater discharges from oil refineries and chemical producers. However, these prior art technologies are not specifically directed to teaching the use of a method and process that uses a high velocity centrifuges that creates g-forces in excess of 8000 g's to assist in the removal of heavy metals, heavy metal substances, or polyfluoroalkyl hydrocarbons, or even organic materials from natural waters, industrial process waters, or municipalities whereas, said methods and processes will produce safe and potable water for human consumption.

Many municipalities, chemical, agricultural, and energy producers are still facing challenges in meeting EPA acceptable levels of heavy metal contamination in public drinking water and wastewater discharge, particularly arsenic, chromium, and lead. Industrial pollutants have continually been found in the natural ground water environments such as ponds, lakes, streams, and rivers.

### SUMMARY OF THE INVENTION

The present invention is directed to a method and a process that comprises an apparatus that is designed to remove harmful inorganic and organic substances from water sources such as oceans, lakes, rivers, streams, ponds, coal ash ponds, mining ore streams, mining ore production wastewater discharges, oil and chemical wastewater discharges, and municipal wastewater processing and discharges. The present invention utilizes a precipitation-centrifugation-filtration method and process to make water safe for human consumption or as desirable discharge effluents back into the natural environment. The present invention is a network of distinct separation methods and processes that when utilized in the procedures described herein will produce potable drinking water that is capable of meeting or exceeding current EPA target goals to reduced heavy metals, harmful organics, and perfluoroalkyls hydrocarbons in drinking water.

The present invention describes an apparatus that is a precipitation-centrifugation-filtration device that is housed on a mobile skid mount. The present invention is described as an apparatus that is a precipitation-centrifugation-filtration device could also be constructed on a stationary platform. The precipitation-centrifugation-filtration device primarily contains an activator tank, an activator compound or an activator solution, a settling tank, a series of pumps, a high velocity centrifuge device, at least four stages filtration unit sections, flowmeters, thermocouple probes, pressure gauges, back flow regulators, open and shut valves, and any other parts or equipment necessary to make said apparatus functional within the scope of the present invention. At least empty two tanks can be used in the method and process of said apparatus for final purification of the processed water of said invention. These two tanks are not housed on the skid mount is also encompassed in the present invention.

The embodiment of said invention is a method and a process that comprises an apparatus that is designed to remove harmful inorganic and organic substances from water sources such as oceans, lakes, rivers, streams, ponds, coal ash ponds, mining ore streams, mining ore production wastewater discharges, oil and chemical wastewater discharges, and municipal wastewater processing and discharges.

In one embodiment of the present invention the apparatus is attached on a skid mount. Another embodiment of the present invention is that the device is mounted on a skid that is mobile.

Yet, another embodiment of the present invention is that it is constructed on a stationary platform or base foundation.

Another embodiment of the present invention is that said apparatus contains necessary parts that are vital to the function of the method and process of said apparatus which is a precipitation-centrifugation-filtration device achieving the means that it was designed to remove from water heavy metals and/or heavy metal substances, undesirable and toxic organic compounds, and polyfluoroalkyl hydrocarbons, wherein said apparatus of the present invention is comprised of; (1) a selected group of chemical compounds identified as an activator compound, whereas said activator compound can be formulated as an aqueous solution, (2) an activator tank or storage tank, (3) a micro pump, (4) at least one flowmeter, (5) at least one pressure gauge, (6) a settling tank, (7) a high velocity centrifuge capable of creating a g-force sufficient to separate out residual heavy metal chelate-activator complexes and/or chelate-ligand-perfluoroalkyl hydrocarbon complexes in the processed water, (8) at least four separate filtration sections designed to house: (A) 5.0 micron polypropylene filter cartridges, (B) 0.5 micron activated carbon filter cartridges, (C) 0.1 micron activated carbon filters and (D) 0.01 micron ultrafiltration (UF) membrane filter cartridges, (9) a centrifugal or displacement pump, (10) At least two purification treating tanks, (11) a skid mount where said apparatus is attached to, (12) casters designed to make the skid mount mobile, (13) swivel tie-down rings that attach the present invention allowing it to be stationary and movable, (14) a network of pluming or piping to transfer water throughout said apparatus, (15) a disinfectant, and (16) an oxidizing agent.

In one embodiment of the present invention is the use of chemical compounds, sometimes referred to in metal coordination chemistry as “ligands”, and hereafter referred to as a “activator compound”, are selected from a group organic and or natural compounds that in chemistry that can chelate to heavy metal ions in solutions.

In another embodiment of the present invention said activator compound can also be formulated as a “activator solution” (diluted solution), preferably an aqueous solution that comprises a water-soluble organic and/or inorganic metal chelator ligand solution or the salt of said metal ligand chelator formulated in water.

In one embodiment of the present invention is the use of a metal ligand compound, hereafter referred to as a “activator solution” is pumped from the activator tank to a settling tank that contains heavy metal/organic hydrocarbons, and polyfluoroalkyl hydrocarbons.

In another embodiment of the present invention said activator solution is used to chelate heavy metals causing such heavy metals/heavy metal substances over time to precipitate out of the water in the settling tank producing reduce metal water.

In yet another embodiment of the present invention said reduced metal water is pumped from the settling tank into a liquid-solids, or a liquid-liquid, or liquid-liquid-solids high velocity centrifuge device housed on the mobile skid mount to further remove entrained ligand-metal and polyfluoroalkyl hydrocarbon-chelate ligand complexes in the reduced metal water.

In yet another embodiment of the present invention said reduced metal water is pumped into a liquid-solids, or a liquid-liquid, or liquid-liquid-solids high velocity centrifuge device housed on a stationary platform or on a permanent foundation structure to further reduce entrained ligand-metal complexes and polyfluoroalkyl hydrocarbon-chelate ligand complexes in the reduce metal water.

In a preferred embodiment of the present invention said reduced metal water is pumped into a liquid-liquid-solids high velocity vertical centrifuge device housed on a mobile skid mount to further reduce entrained ligand-metal complexes and polyfluoroalkyl hydrocarbon-chelate ligand complexes in the reduced metal water.

Another embodiment of the present invention is that said liquid-liquid, or liquid-solids, or liquid-liquid-solids high velocity centrifuge device is capable of creating a sufficient g-force that will separate the reduced metal water stream from any oil/hydrocarbon entrained substances that may be mixed or entrained in the reduced metal water stream provided that such oil/hydrocarbon substances have a density less than 1.0 g/ml.

Yet, another embodiment of the present invention is that said liquid-liquid, or liquid-solids, or liquid-liquid-solids high velocity centrifuge device is capable of creating a sufficient g-force that will separate out any heavy chemical/material substances, herein after identified as “bottoms”, from water which has a density greater than 1.0 g/ml.

A further embodiment of the present invention that details said apparatus is that reduced-reduced metal water (effluent) from the high velocity centrifuge device is pumped through a four-stage filtration section located on the mobile skid whereas such filtration sections are suitable to remove organics, chlorine, chloramines, amines, phosphates, polyfluoroalkyl substances, trace heavy metals, and microorganisms such as fungi, bacteria, protozoa's, and other lower life cell forms that may be present in the reduced-reduced metal water.

Yet, another embodiment of the present invention the water reduced-reduced metal stream (effluent) from the high velocity centrifuge device is pumped through a four-stage filtration which is located on a stationary platform or a permanent base foundation which also houses said apparatus, whereas such filtration sections are suitable to remove organics, chlorine, chloramines, amines, phosphates, polyfluoroalkyl substances, trace heavy metals, and microorganisms such as fungi, bacteria, protozoa's, and other lower life cell forms that may be present in the reduced-reduced metal water.

Still further, a further embodiment of the present invention that describes said apparatus is that the purified water that exits the four stage filtration system is transferred to at least two stationary holding tanks for purification of viruses and mold. Finally, another embodiment of the stated said apparatus is that said precipitation ultracentrifugation-filtration-purification apparatus produces a clean and safe water product suitable for human consumption or desirable for environmental discharge.

### BRIEF DESCRIPTION OF THE DRAWINGS

FIG. 1

Details illustration of flow chart diagram. (1) Activator tank, (2) micro pump, (3), settling tank, (4) centrifugal pump, (5) high velocity centrifuge device, (6)(7)(8)(9)(10) minor but necessary auxiliary components of the invention, (11) 1^{st} stage filter section, (12), 2^{nd} stage filter section, (13) 3^{rd} stage filter section, (14) 4^{th} stage filter section, (15)(16)(17)(18)(19) minor but necessary auxiliary components of the invention, (20) 1^{st} stage purification, (21) 2^{nd} stage purification.

FIG. 2A

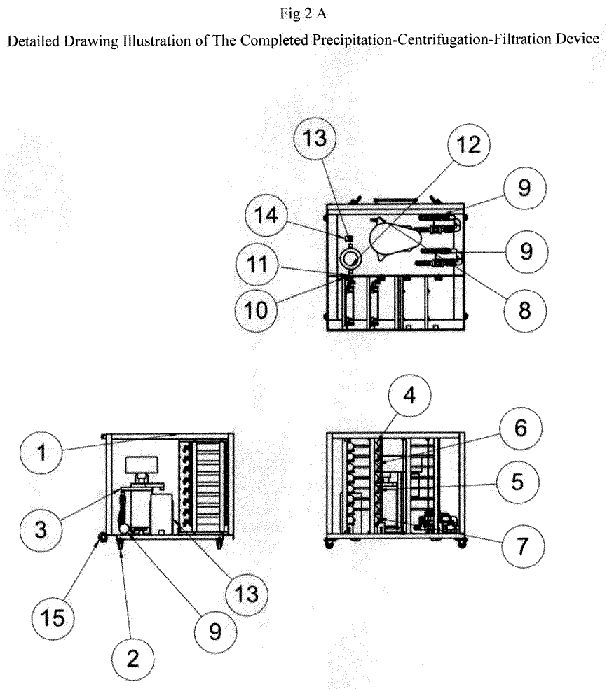

Detailed illustration drawings of the said apparatus of the instant invention which is a precipitation-centrifugation-filtration device system.

FIG. 2 B

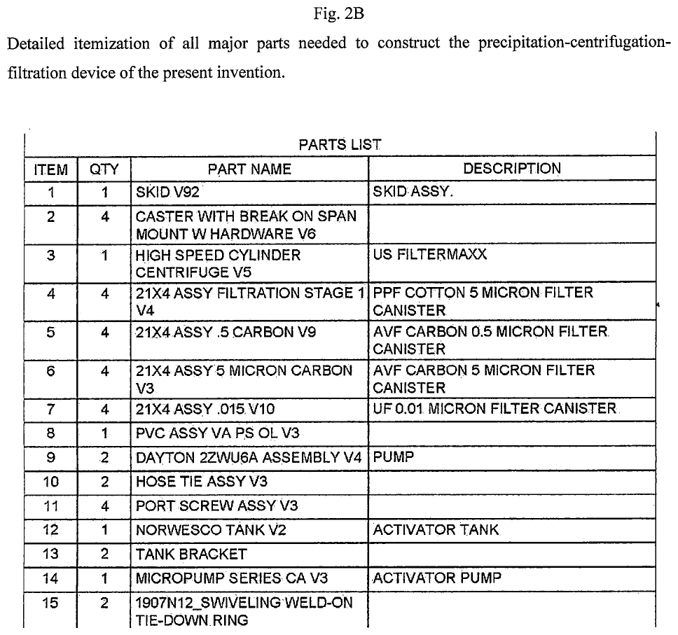

Detailed itemization of all major parts needed to construct the precipitation-centrifugation-filtration device of the present invention.

FIG. 3

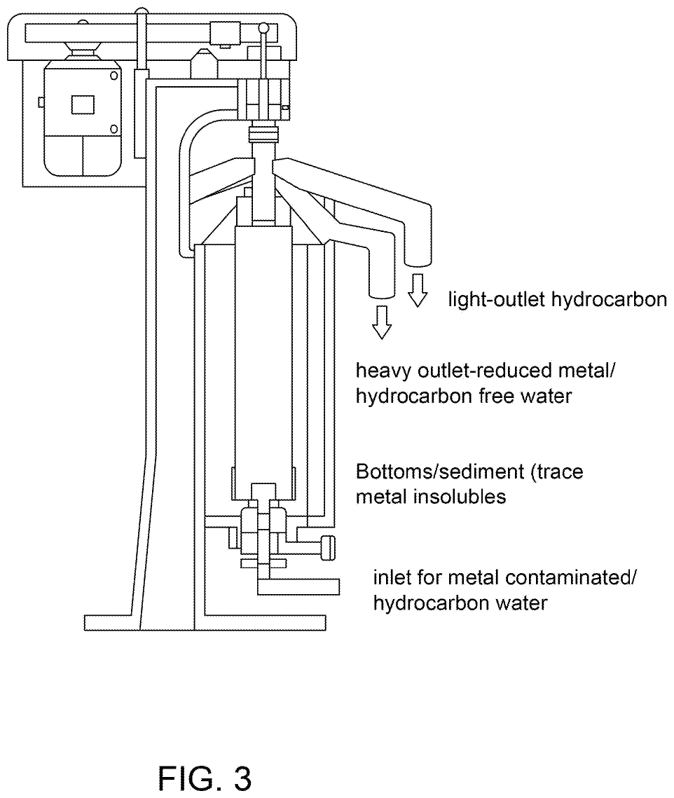

Illustrates a sketched drawing of the preferred high velocity centrifuge device which is a GF75 High Velocity Vertical Tubular Centrifuge liquid-liquid-solids device for use in said apparatus of the present invention. The reduced metal water enters inlet (1) on the centrifuge, and by the use of centrifugal force the oil/hydrocarbon materials with density less than 1.0 g/mL exit outlet valve (3), the reduced metal water flow will exit valve (2), and any substances with a density greater than 1.0 g/ml will fall to the bottom (4) of the centrifuge in a removable bowel housed inside the centrifuge device.

### DETAILED DESCRIPTION

An apparatus that is a water purification device that comprises a method and a process network components that are functional systems to remove harmful inorganic and organic substances present in lakes, ponds, rivers, oceans, streams, coal ash ponds, mining streams, mining production, industrial, chemical, and municipal wastewater discharges.

The present invention is directed to a method and process to remove heavy metals such as, but not limited to iron, arsenic, lead, chromium, cadmium, cobalt, mercury, nickel, vanadium, copper, gold, platinum, silver, manganese, uranium, and the like. The present invention is directed to a method and a process to remove harmful inorganic heavy metals such as but not limited to mercury, lead, cobalt, cadmium, vanadium, chromium, mercury, and arsenic all which have been found to be present in industrial wastewater discharge and in many cases even public drinking water reservoirs, often time at concentration levels that have been determined to be significantly dangerous to health of the public if consumed. Even common biological important metals such as iron and copper could be dangerous to aquatic life and some mammalian organisms if found in high concentrations levels in the environment.

The present invention is directed to a method and process to remove organic substances from water streams and other water resources, (ponds, lakes, streams, rivers, etc. Organic pollutants mentioned herein, could be but not limited to benzene, acrylamides, chlorobenzene, dichloroethylene, chloramines, chlorine, chlorine dioxide, dioxin, di(ethyl-hexyl) phthalate, ethylene dibromide, perfluoroalkyl hydrocarbons, and other industrial chemicals from energy, chemical, and agricultural industries have also been found in public drinking water resources.

The present invention is an apparatus wherein said apparatus comprises a method and a process network of functional systems when utilized in the present invention described herein will produce potable drinking water that is capable of meeting or exceeding current EPA target goals of reduced heavy metals and harmful organic substances in drinking water. Current EPA acceptable levels for leas and arsenic is 15 ppb and 10 ppb, respectively. Under the new EPA Safe Water Drinking Act, target goals for lead and arsenic levels in drinking water will be 0 ppb and 3 ppb. These new limits are necessary because lead and arsenic are toxic metals that can accumulate over time in the human body.

The present invention utilizes a precipitation-centrifugation-filtration method and process to make water potable for human consumption and/or make water a safe to be discharged back into the natural environment. Said present invention utilizes a precipitation-ultracentrifugation-filtration methods and processes that produces a clean and safe water product suitable for human consumption or desirable for environmental discharge. It is further understood that the present invention will help municipalities and industrial water producers to meet the new EPA target goals for toxic metal levels for drinking water or wastewater discharge.

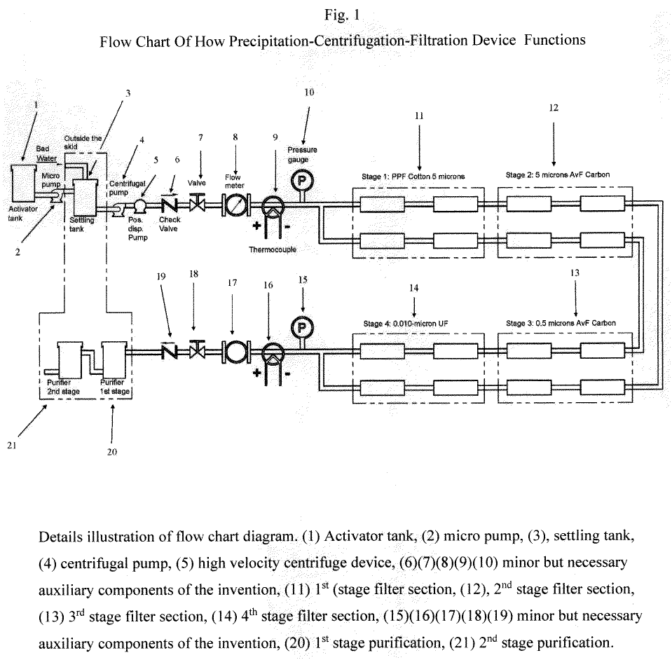

The following is a detailed description of the present invention as illustrated in flow chart (FIG. 1),

Item 1

Activator storage tank—contains a 0.5% to 75% a metal chelator substance in water.

Item 2
a micro pump that can transfer the metal chelator solution from activator storage tank to the settling tank.

Item 3

A settling tank which receives the incoming bad water and activator solution when both mix results in the immediate precipitation of metals out of water (metals, organics).

Item 4—A centrifugal pump to transfer the reduced heavy metal water is transferred into

Item 5—a liquid-solids, or a liquid-liquid, or liquid-liquid-solids high velocity centrifuge which separates out water, oil, and residual ligand-metal and perfluoroalkyl hydrocarbon complex into two separate steams, (1) water, (2) oil/hydrocarbon (density <1.0 g/ml) and (3) a bottoms material, heavy metal-ligand complexes (density >1.0 g/ml).

Item 6,7,8, 9, and 10 (check valve, open-shut valve, flow meter, thermocouple, pressure gauge) are auxiliary components of the invention that help regulate and monitor the state of the water streams as it flows through the invention device.

Item 11-1st stage filter section.

Item 12-2nd stage filter section.

Item 13-3rd stage filter section.

Item 14-4th stage filter section.

Item 15,16,17, 18, and 19 (check valve, open-shut valve, flow meter, thermocouple, pressure gauge) are auxiliary components of the invention that help regulate and monitor the state of the water streams through the invention.

Item 20-1st stage purification tank.

Item 21-2nd stage purification tank.

In one embodiment of the present invention an activator storage tank “item 1” can be fabricated from common industrial materials, preferably but not limited to stainless-steel, or fabricated from plastic, preferably but not limited to high density polyethylene. The activator storage tank holds the activator solution and could be attached to the skid mount of said apparatus. The activator storage tank could optionally be detached from the skid mount and used at a remote location.

In another embodiment of the present invention wherein said “activator compound” in aqueous solution is a metal chelator ligand compound. For the purpose of this invention the metal chelator ligand can be used as a solid or liquid to satisfy the utility of this invention. The said “activator compound” is selected from the group consisting of alpha lipoic acid, sodium lipoate, potassium lipoate, green tea extract (comprised of catechin, epicatechin, gallocatechin, epigallocatechin, epigallocatechin gallate), grape seed extract (comprised of monomers, oligomers, polymers of proanthocyanins), n-acetylcysteine, cysteine, and L-arginine, alpha-ketoglutarate, glutamine, ethylenediaminetetraacetic acid, sodium ethylenediaminetetraacetic acid, calcium ethylenediaminetetraacetic acid, and dimercaptosuccinic acid, ethylene diamine, tetraethylethylenediamine, tetramethyethylenediamine, tetraethylenepentadiamine.

In another embodiment of the present invention the activator compound is formulated as a solution, preferably an aqueous solution that comprises a water-soluble organic ligand chelator or the salt of an organic ligand chelator formulated from 0.5% to 75% composition in water. Most preferably, the activator concentration is in the range of 2 to 25%. One aspect of the present invention is the activator solution is 5% L-arginine in water. Another aspect of the invention is that the activator solution is 5% potassium lipoate in water.

Yet in another embodiment of said apparatus wherein the concentration of said activator compound to be used to effectively remove heavy metals/and or heavy metal substances is based on the molar concentration of said activator to metal, for example, molar ratios of 2:1, 3:1, or 4:1, with the final concentration of activator compound used to be determined by the known molar concentration levels of heavy metals and perfluoroalkyl hydrocarbons in the water.

Yet another embodiment of the present invention is that the activator compounds can be used as individual additives to chelate heavy metal contaminated water, or they can be mixed together. A blend of activators could be at a ratio of 1:1, 1:2, or 2:1 depending upon these selected activators. One example of an activator blend would be a 1:1 ratio (molar basis) of alpha-ketoglutarate and n-acetylcysteine. Another blend could be a 1:1 ratio of L-glutamine and alpha-ketoglutarate. Still a further blend of activator compounds could be a 1:1 ratio of grape seed extract and potassium lipoate. The concentration use of the activator (s) is based on molar concentration of activator to metal, for example 2:1, 3:1, or 4:1, with the final concentration of activator added to the contaminated water streams being determined by the known concentration levels of heavy metals in solution.

In another embodiment of the said apparatus invention is micropump ‘item 2” is a device that is a mechanical or digital instrument that is located on said apparatus water purification device wherein said micropump has an adjustable flow rate capacity and is capable of pumping or transferring said activator solution to the settling tank #3.

In another embodiment of the present invention is settling tank #3 which receives the incoming bad water and activator solution when both mix results in the immediate precipitation of metals out of water (metals, organics).

In another embodiment of said invention the activator solution is pumped from the activator tank #1 into the settling tank #3 by way of the said micro pump on the skid mount. It is also an extension of the present invention that the activator could be added to the settling tanks by other means for example, a centrifugal pump. The activator solution could also be added into the settling tank #3 simply by manual addition from a container or by means of a syringe. The interaction of the activator with heavy metals and/or heavy metal inorganic or organic complexes causes such heavy metals to precipitate out of the water medium.

In another embodiment of said invention is that the activator compound that is pumped to settling tank #3 can chelate heavy metals such as but not limited to iron, arsenic, lead, chromium, cadmium, cobalt, mercury, nickel, vanadium, copper, uranium, and the like. The treatment of water containing heavy metals with said activator compounds described herein causes such heavy metals to precipitate out of solution, whereas, said solution in most cases is an aqueous medium but not limited to thereof.

Still, in another embodiment of the present invention the ligand (activator)-metal complex is allowed to precipitate out of solution in the settling tank #3 over a period of time from 1 hour to 5 days, but preferably from 1 hour to 24 hours. The interaction of the metal ligand chelate with heavy metals and/or heavy metal inorganic or organic complexes causes such heavy metals to precipitate out of the water and the interaction of the activator compound with perfluoroalkyl hydrocarbons forms electrostatically water unstable perfluoroalkyl complexes making them easy to be removed from water by gravity methods or chemical adsorption.

In another embodiment of the present invention is that centrifugal pump #4 transfers the reduced metal water from the settling tank #3 by via a transfer line network system located on said apparatus whereas said transfer line network system could be constructed of some form of plastic, composite, or metal material, which could in one embodiment of the invention, run overhead the settling tank #3 or into the side of said settling tank, and then down into the water level, but not reaching the precipitated insoluble metal-activator-complex materials.

In another embodiment of the present invention the reduced heavy metal water is pump from the settling tank #3 via transfer line network system located on said apparatus into liquid-solids, liquid-liquid, or liquid-liquid-solids a high velocity centrifuge #5 capable of producing a g-force from 1,500 g's to 30,000 g's.

Yet, still in another embodiment of the present invention that the liquid-solids, liquid-liquid, or liquid-liquid-solids high velocity centrifuge #5 capable of producing a g-force from 1,500 g's to 30,000 g's. The 1,500 g's to 30,000 g's high velocity centrifuges is capable of separating water, oil/liquid hydrocarbons, and high molecular weight and/or substances with a density greater than 1.0 g/ml (bottoms). It is understood that residual heavy metal activator chelates could be in the bottoms material. The interaction of the metal ligand chelator with heavy metals and/or heavy metal inorganic or organic complexes causes such heavy metals to precipitate out of the water and the interaction of the activator compound with perfluoroalkyl hydrocarbons forms electrostatically water unstable perfluoroalkyl complexes making them easy to be removed from water by gravity methods or chemical adsorption.

One aspect of the present invention the high velocity centrifuge #5 could be but not limited to would be the GF75 Tubular Vertical Centrifuge for water-oil-solid separation. One aspect of the present invention is that the high velocity centrifuge would be a liquid-liquid-solids GF75 Tubular Vertical centrifuge which can create a g-force 8,000 g's to 20,000 g's needed to separate water streams, oil streams, and heavy metals chelates. The GF75 Tubular Vertical Centrifuge will produce reduce heavy metal water at the water outline valve. The water stream exits the water outlet valve, the oil stream exits the oil outlet valve, and the heavy metal chelate is trapped in a bowl located at the bottom of the centrifuge, The high velocity centrifuge could have a bowel discharge that is manually or one that is continuous.

Another embodiment of the present invention is that the reduced metal water exits the water outlet valve of the GF75 Tubular Vertical Centrifuge and is transferred via transfer line network system into a 1^{st} stage filtration section #11 that could contain a synthetic cotton melt-down blown filter, a synthetic cotton pleaded sediment filter, a synthetic cotton string-wound sediment filter, or a synthetic cotton bag filter contained in a canister, or a suitable holding compartment.

Still a further embodiment of 1^{st} stage filtration section #11 is used to remove debris and small particulate matter that may have exited the high velocity centrifuge with the reduced metal water stream. The 1^{st} stage filters could be composed of a synthetic polyester material, synthetic hydrophobic sulphone material, or synthetic cotton polypropylene material. The preferred filter material for the 1^{st} stage filtration section is a filter composed of spun multi-layer density polypropylene or polyester contained in the appropriate housing. The 1^{st} stage synthetic filters are capable of removing particle substances in size from 100 microns to 5 microns, but preferably 5 microns at normal pressures and ambient temperature.

Another embodiment of the present invention is that the 1^{st} stage filtration section #11 could contain 1 to 50 polypropylene units (filter+housing canister), but preferably from 4 to 12 units. The desired number of polypropylene filter units will depend upon how much water needs to be processed on a daily basis. A further embodiment of the present invention wherein the polypropylene or polyester filters in the 1^{st} stage filtration section #11 is contained in a housing canister, or suitable compartment. The filter canister housing could be made out of a synthetic plastic or metal material, preferably, stainless-steel.

Another embodiment of the present invention is that the reduced-reduced metal water exits the last filtration unit of the 1^{st} stage filtration section and is transferred to a 2^{nd} stage filtration section that contains a carbonaceous material or an activated carbon filtering material contained in a housing canister, or suitable housing contained in a filtering housing unit. The activated carbon filter can be manufactured either by the process of carbonization or thermal activation.

Thermal activation or chemical activation are means to produce the activated carbon filters used in the 2^{nd} stage filtration section.

In another embodiment of said invention the activated carbon filter could be made from but not limited to coconut shells, wood, paper, coal, charcoal, bamboo shoots, lignite, petroleum pitch, and peat. The activated carbon in the filter could be granular, extruded, powdered, or bonded powdered (polymer coated). The activated carbon material suitable for the 2^{nd} stage filtration section should have an internal surface of 500 m²/g to 3500 m²/g. The activated carbon filter could have a micron rating from 1 micron to 50 micron, but preferably 1 micron to 10 micron, and most preferably 5-micron rating. The activation carbon filters located in the 2^{nd} stage filtration section are designed to remove trace heavy metals, organic amines, heavy and light mineral oils, polycyclic aromatic hydrocarbons, nonpolar hydrocarbons, polar hydrocarbons, chlorides, chlorine, Iodine, Fluorene, BETX, phenol, halogenated organic substances, water soluble metallo-complexes, yeasts, and various fermented substances.

The activated carbon filter in the 2^{nd} stage filtration section is contained in a housing canister unit that has an inlet and outlet that allows the reduced-reduced metal water to enter the housing canister, contact thoroughly the activated carbon filter, and an outlet on the housing canister allows the reduced-reduced metal water to exit the housing canister. The filter housing canister could be made out of a synthetic plastic or metal material, preferably, stainless-steel. The 2^{nd} stage filtration section could contain 1 to 50 activated carbon filter units (filter+housing canister), but preferably could contain 4 to 12 units. The desired number of activated carbon filter units will depend upon how much water needs to be process on a daily basis.

Still yet another embodiment of the present invention is that the reduced-reduced metal water exits the last filtration unit of the 2^{nd} stage filtration section being transferred via a transfer line network system located on said apparatus frame to a 3^{rd} stage filtration section that contains a carbonaceous material, or an activated carbon filtering material contained in a filtering housing unit. The activated carbon filter can be manufactured either by the process of carbonization or activation. Thermal activation or chemical activation are means to produce the activated carbon filters used in the 3^{rd} stage filtration section. The activated carbon filter could be made from but not limited to coconut shells, wood, paper, coal, charcoal, bamboo shoots, lignite, petroleum pitch, and peat. The activated carbon in the filter could be granular, extruded, powdered, or bonded powdered (polymer coated). The activated carbon material suitable for the 3^{rd} stage filtration section should have an internal surface of 500 m²/g to 3500 m²/g. The activated carbon filter could have a micron rating from 0.1 micron to 10 micron, but preferably 0.1 micron to 0.5 micron, and most preferably 0.5-micron rating. The activation carbon filters located in the 3^{rd} stage filtration section are designed to remove trace heavy metals, organic amines, heavy and light mineral oils, polycyclic aromatic hydrocarbons, nonpolar hydrocarbons, polar hydrocarbons, chlorides, chlorine, Iodine, Fluorene, BETX, phenol, halogenated organic substances, water soluble metallo-complexes, perfluoroalkyl substances, yeasts, and various fermented substances.

A further embodiment of said invention is that the activated carbon filter in the 3^{rd} stage filtration section is contained in a housing canister unit that has an inlet and outlet that allows the reduced-reduced metal water to enter the housing, contact thoroughly the activated carbon filter, and an outlet on the housing allows the reduced metal water stream to exit the housing. The filter housing could be made out of a synthetic plastic or metal material, preferably, stainless-steel. The 2^{nd} stage filtration section could contain 1 to 50 activated carbon filter units (filter+housing canister), but preferably could contain 4 to 20 units. The desired number of activated carbon filter units will depend upon how much water needs to be processed on a daily basis.

Even more still another embodiment of the present invention is that the reduced metal water stream exits the last filtration unit of the 3^{rd} stage filtration section and is transferred via a transfer line network system located on said apparatus frame to a 4^{th} stage filtration section that contain ultrafiltration membrane filter (UF) contained in a housing canister or suitable housing. The UF filter membranes could be either in the form of flat sheet element, a spiral wound element or a tubular element known as a hollow fiber. The UF filter membranes could be composed of polylactic acid, ceramics, cellulose acetate, polypropylene, polysulfone, polyvinylidene fluoride, polyether sulfone, cellulose esters, and polyacrylonitrile. To satisfy the teachings of the present invention the UF filter membranes could have pores sizes that range from 0.001 micron to 0.1 micron, but preferably 0.001 micron to 0.03 micron. The UF filter membrane can be manufactured by a process called phase inversion. The UF membranes in the 4^{th} stage filtration section are designed to remove from the reduced-reduced water bacteria, protozoans, viruses, benzene, chlorine, proteins, pesticides, herbicides, perfluoroalkyl hydrocarbons, and cryptosporidium.

The UF filter membranes filters in the 4^{th} stage filtration section are contained in a housing canister unit or a suitable housing container that has an inlet and outlet that allows the reduced-reduced metal water to enter the housing canister, contact thoroughly the UF filter membrane and an outlet on the housing allows the reduced-reduced metal water to exit the housing canister. The filter housing canister could be made out of a synthetic plastic or metal material, preferably, stainless-steel. The 4th stage filtration section could contain 1 to 50 UF filter units (filter+housing canister), but preferably could contain 4 to 20 units. The desired number of UF filter membranes units will depend upon how much water needs to be processed on a daily basis.

Further still, another embodiment of the present invention is that the reduced-reduced metal water exits the last filtration unit of the 4^{th} stage filtration section being transferred via a transfer line network system located on said apparatus to a 1^{st} stage purification tank. The processed water in this tank is free of heavy metals, hydrocarbons, halogens, halogenated hydrocarbons, harmful microorganisms, and other chemicals that are toxic and harmful to humans and is now “purified water”. For final quality assurance and to ensure that the integrity of the purified water will be safe for future human consumption and to prevent possible mole formation while the purified water is stored in tanks the purified water is treated with an aqueous solutions of a disinfectant agent that includes but is not limited to hypochlorous acid, sodium hypochlorite, potassium hypochlorite, calcium hypochlorite, magnesium hypochlorite, acetic acid, boric acid, and borax. The aqueous disinfectant agent solution could contain from 1% to 10% disinfectant agent but more preferably, the disinfectant agent will contain 4% to 8% of the disinfectant material. Preferably, the disinfectant agent is sodium hypochlorite. The sodium hypochlorite concentration in the drinking water in the 1^{st} stage purification section could range from 1 mg/L to 50 mg/L, but more preferably 3 mg/L to 8 mg/L. The purified water is allowed to set in purification tank from 15 minutes to 24 hours, but preferably 1 hour to 5 hours.

Yet, another embodiment of the present invention is that the purified water stream exits the 1^{st} stage purification tank being transferred via a transfer line network system located on said apparatus to a 2^{nd} stage purification tank. To the purified water in the 2^{nd} stage purification tank is added an aqueous solution of hydrogen peroxide. The aqueous hydrogen peroxide solution could have a concentration of 1 to 20% hydrogen peroxide in water but preferably, 1 to 8% hydrogen peroxide in water. Sufficient hydrogen peroxide is used to eliminate excessive chlorine in the purified water and to ensure that the final water product meets the EPA levels for chlorine of 4 mg/L or less.

Yet another embodiment of the present invention is that the precipitation-centrifugation-filtration device can be control manually with open and shut off valves, on and off switches, and other mechanical auxiliary equipment. Another aspect of the present invention is that if desired the invention can be controlled by means of automation that uses electronic technology that its commercially available that monitors, records, transmits, and manages the functions associated with operation of the precipitation-centrifugation-filtration device.

Proof of Invention Concept

We examine the use of the natural amino acid L-Arginne on the removal of iron (Fe³⁺) as iron (III) chloride, lead (Pb²⁺) as lead (II) nitrate, chromium (Cr³⁺) as chromium (III) nitrate, cadium (Cd²⁺) as cadium (II) sulfate hydrate, and arsenic in a fly ash sample from a plant in North carolina. We predict that L-Arginnie will bind to Fe³⁺ in aqueous medium as a bidentate, 3:1 coordination complex, facilitating the precipitation of iron out of water.

Procedure for Testing Lead Removal
Make a 5 ppm by weight Pb²⁺ solution in distilled water using Pb(NO3)₂.
Pb(NO3)₂ MW 331.20, Pb MW 207.2, 62.56%.
Solution volume 5.0 gallons=3785 mL×1 g/mL 5.0=18,925g
Use 0.15249 g Pb(NO3)₂
g Pb=0.15249 g×0.6256=0.0954 g Pb/18925×1.0 6=5.04 ppm=5,040 ppb
moles Pb=0.0954 g Pb/207.2 g Pb=0.00046043 moles Pb
#moles L-Arginine needed to chelate Pb²⁺ at 3:1 ratio (Mw. L-Arginine 174.20 g)
0.00046043 mol Pb×3 mol LA/1 mol Pb=0.0013813 mole LA×174.2g LA/1 mol LA=0.24062 g LA

Procedure for Testing Iron Removal
Make a 10 ppm by weight Fe³⁺ solution in distilled water.
FeCl₃×6H2O MW 270.30; Fe MW 55.85, Fe 20.66% by wt. in FeCl₃×6H₂O.
% Fe=55.85/270.30=0.2066×100=20.66%
Solution volume 5.0 gallons=3785 mL×1 g/mL=18,925g
0.9450 g FeCl₃×6H₂O/18925 g×1×10⁶=49.933 ppm FeCl₃×6H₂O
g Fe in 5.0 water=0.9450 g×0.2066=0.19533 g Fe
0.19533/18925×1×10⁶=10.32 ppm Fe or 1000 ppb/1 ppm=10,320 ppb Fe
moles of Fe=0.19533 g Fe×1 mole Fe/55.85 g Fe=0.0034974 moles Fe
#moles L-Arginine needed to chelate Fe³⁺ at 3:1 ratio (Mw. L-Arginine 174.20 g)
0.0034974 mol Fe×3 mol LA/1 mol Fe=0.0104922 mole LA×174.2g LA/1 mol LA=2.100 g LA
Procedure for Testing Cadmium Removal
Make a 50 ppm by weight Cd²⁺ solution in distilled water.
CdSO₄·8/3 H2O MW 256.467; MW Cd 112.41, Cd 43.83% by wt. in CdSO₄·8/3 H2O.
% Cd=55.85/270.30=0.2066×100=20.66%
Solution volume 5.0 gallons=3785 mL/gallon×5.0×1 g/mL=18,925g
2.15834 g CdSO₄·8/3 H2O/18, 925 g×1×10⁶=114.04 ppm CdSO₄·8/3 H2O
g Cd in 5.0-gallon water=2.15834 g×0.4383=0.946 g Cd
0.946/18,925×1×10⁶=49.99 ppm Cd or 1000 ppb/1 ppm=49,990 ppb Cd
moles of Cd=0.946 g Cd×1 mole Cd/112.41 g Cd=0.00841562 moles Cd
#moles L-Arginine needed to chelate Cd²⁺ at 3:1 ratio (Mw. L-Arginine 174.20 g)
0.00841562 mol Cd×3 mol LA/1 mol Cd=0.25246864 mole LA×174.2g LA/1 mol LA=4.34 g LA

Transfer the calculated mass in grams of each metal salt compounds into individually 5.0 gallon jugs of distilled water. Shake the 5-gallon jugs of distilled water and salt solutions vigorously and allow each test jug to set until all the salts have completely dissolved into solution. To each individual 5-gallon jug add the calculate amount of LA for each metal salt and again shake the 5 gallon jugs vigorously to mix components. Observed precipitation should begin to emerge 5 minutes after the LA addition. Allow the mixture/solution to stand for the next 24 hours.

Before passing each treated metal salt solutions through the precipitation-centrifugation-filtration-purification process (PUCFPS) device, the components of the apparatus of said invention was pre-washed using a 2.0 gallon distilled water. Approximately 2.0 gallons was pump through said apparatus before each test run to ensure that the system was clean as well as to collected a water sample on a finished process water to be used as a baseline control. Following the pre-washing phase the PUCFPS the on and off valve to the main feed line was engaged to the treated 5.0 gallon metal salt/LA/water mixture and the test was stared. The process flow rate was 0.541 gallons per minute at 23.3° C. at 1.0 atm. The tests ran for approximately 35 minutes an sufficient samples of each run was collected once the waters completed the final purification process.

250 mL samples of the processed metal salt/LA water solutions were sent to Simplelabs. Inc located in Berkley, California. The table below illustrates the effectiveness of the precipitation-centrifugation-filtration (PUCFPS) method and process in removing heavy metals from water. The method of analysis used here has a detection level of 0.1 ppb. The data below illustrates the findings.

| | | Spike | Ion Conc. | Ion | Ion Conc. | |
|---|---|---|---|---|---|---|
| Sample ID | Spike Com* | M. Ion | (ppb) | Detected A | (ppb) | PUCFPS |
| Distilled Water N/A | | N/A | N/A | N.D. | N.D. | No |
| D-6577 | Pb(NO₃)₂ | Pb²⁺ | 5,041 | N.D. | N.D. | Yes |
| | | | | Fe³⁺ | 6.4^{b} | |
| O-4217 | CdSO₄•8/3 H2O | Cd²⁺ | 49,990 | N.D. | N.D. | Yes |
| | | | | Cr³⁺ ** | 0.5 | |
| S-2354 | Cr(NO₃)₃ | Cr³⁺ | 10,917 | N.D. | 0.5*** | Yes |
| E-5231 | FeCl₃ | Fe³⁺ | 10,320 | Fe | 0.7 | Yes |
| Fly Ash, NC | Asª | Asª | 100ª | N.D. | N.D. | Yes |
| | N/A | N/A | N/A | Cr | 0.8^{c} | Yes |
| | N/A | N/A | N/A | Fe | 2.1^{d} | Yes |

*Distilled water sample was spike with labeled metal salt
** CdSO₄•8/3 H2O material purchased is believed to contain minute Cr as a contaminate. The addition of the ligand was based solely on the molar concentration of the Cd ion and the molar concentration was not factored in the calculations.
^{a}the concentration of arsenic in the fly ash is an approximate calculated value based on past fly ash samples from the plant and from literature data.
^{b}Pb(NO₃)₂ material purchased is believed to contain minute Fe compound as a contaminate. The addition of the ligand was based solely on the molar concentration of the Pb ion and the molar concentration of the Fe ion was not factored in the calculations.
^{c}based on literate data on numerous fly ash samples it was not expected to find Cd in the solid fly ash matrix material.
^{d}based on literate data on numerous fly ash samples it was not expected to find Fe in the solid fly ash matrix material.
***the calculated average of two runs.
Other laboratory testing has demonstrated that alpha lipoic acid, grapeseed extract, green tea extract, alpha ketoglutarate/glutamine, and alpha ketoglutarate/NAC all give similar results as L-arginine for the removal of heavy metals from water.

The scope of this disclosure should be determined by the appended claims and its legal equivalents. Therefore, it would be appreciated that present disclosure fully encompasses other embodiments. In the present disclosure, reference to an element in the singular is not to intended to mean “one and only one” unless explicitly so stated, but rather, “one or more”. All structural, chemical, and functional equivalents to the above described embodiment(s) are incorporated herein by reference and are intended to be encompassed by the present claims.

I claim:

1. An apparatus that comprises a method and a process network of functional systems constructed to remove harmful inorganic and organic substances present in natural or man-made water sources and industrial processes with said apparatus comprising:
A tank that stores the activator compound or activator solution;
An “activator compound or activator solution”;
A micro pump;
A device capable of transferring water, water-based mixtures, or aqueous solutions;
A device capable of measuring liquid flow rates;
A device capable of measuring pressure or pressure changes created by the flow of a liquid through a tube or pipe;
settling tank(s);
A high velocity centrifuge capable of creating a g-force sufficient to separate out heavy metal residual chelate-activator complexes and perfluoro alky hydrocarbons;
A 1^{st} stage filtration section suitable for removing debris and small particulate matter;
A 2^{nd} stage filtration section suitable for removing organic compounds, chlorine, and chlorinated hydrocarbons;
A 3^{rd} stage filtration section suitable for removing yeasts, fermented substances, and polyfluorinated hydrocarbons;
A 4^{th} stage filtration section suitable for removing residual perfluoroalkyl hydrocarbons, cryptosporidium, and viruses;
A 1^{st} stage purification treating tank;
A 2^{nd} stage purification treating tank;
A disinfectant agent;
An oxidizing agent;
A skid mount designed to house said apparatus;
A stationary platform or base foundation to house said apparatus.

2. A method and process of claim 1 wherein said activator tank is a “storage tank” that can be fabricated from common industrial materials. The storage tank could be attached to the skid frame of said apparatus. The activator storage tank could optionally be detached from the skid mount and used at a remote location.

3. A method and process of claim 2 wherein said storage tank has a volume capacity which could range from 0.5 gallons to 1000 gallons.

4. A method and process of claim 3 wherein said storage tank is used to store the “activator” compound or activator solution.

5. A method and process of claim 1 wherein said “activator” is a metal chelator ligand compound which can be a solid, liquid, or a diluted solution, preferably an aqueous solution that comprises a water-soluble organic metal chelator ligand solution or the salt of an organic metal ligand chelator in solution.

6. A method and process of claim 5 wherein said metal chelator ligand solution can be added to water sources or streams that have been identified as containing heavy metals or heavy metal compounds wherein said metal chelator ligand solution is capable of removing heavy metals and/or heavy metals compounds from said water sources or streams.

7. A method and process of claim 1 wherein said micropump which is mounted to the skid mount of said apparatus is connected to the beforehand mention activator storage tank via a transfer line network system located on herein said apparatus housing.

8. A method and process of claim 7 wherein said micropump is capable of transferring or moving the beforehand mentioned metal chelator ligand solution through transfer line network system located on apparatus housing.

9. A method and process of claim 1 wherein said settling tank is located adjacent to or near said apparatus of the instant invention.

10. A method and process of claim 9 wherein said settling tank is constructed from common industrial materials such as metals, plastics, and composites. The settling tank could have a holding volume capacity of, but not limited to 500 to 100,000 gallons.

11. A method and process of claim 10 wherein said settling tank contains water contaminated with heavy metals or heavy metal compounds and/or undesirable organic compounds, chlorinated hydrocarbons, and perfluoroalkyl hydrocarbons.

12. A method and process of claim 1 wherein said beforehand mention metal chelator ligand solution is pumped from the activator storage tank via the micropump device to the settling tank that holds the heavy metal and/or heavy metal compounds/organic water compounds, and perfluoroalkyl hydrocarbons.

13. A method and process of claim 12 wherein said beforehand mention metal chelator ligand solution will chelate heavy metals and/or heavy metal compounds causing such heavy metals over time to precipitate out of the water in the settling tank whereas such heavy metal precipitation produces a reduced-metal water solution.

14. A method and process of claim 1 wherein said reduced-metal water is transferred into a liquid-solids, or a liquid-liquid, or liquid-liquid-solids high velocity centrifuge device via a direct displacement or centrifugal pump whereas, such high velocity centrifuge further reduce entrained ligand-metal complexes in the reduced-metal water.

15. A method and process of claim 14 wherein said liquid-liquid, or liquid-solids, or liquid-liquid-solids high velocity centrifuge device is capable of creating a sufficient g-force of but not limited to at least 1500 g's whereas said g-force is sufficient to separate by gravity a reduced metal water stream from any oil/hydrocarbon entrained substance that may be mixed or entrained in the reduced metal water provided that such oil/hydrocarbon substances have a density of less than 1.0 g/ml.

16. A method and process of claim 1 wherein said liquid-liquid, or liquid-solids, or liquid-liquid-solids high velocity centrifuge device is capable of creating a sufficient g-force of at least 1500 g's whereas said g-force is sufficient to separate out any heavy chemical/material substances, herein after identified as “solids or bottoms” from the reduced metal water whereas such “solids or bottoms” substance have a density greater than 1.0 g/ml.

17. A method and process of claim 1 wherein said reduced metal water stream is transferred via a transfer line network system located on herein said apparatus through a 1^{st} stage, a 2^{nd} stage, a 3^{rd} stage, and a 4^{th} stage filtering sections. The 1^{st} stage filtering section will remove trace heavy metal/chelate materials, debris, and small particulate matter. The 2^{nd} and 3^{rd} stage-stage filter sections will remove organics, chlorine, chloramines, amines, phosphates, protozoa's, trace heavy metals polyfluoroalkyl substances, and fungi. The 4^{th} stage filter section will remove microorganisms like bacteria, viruses, and other lower life cell forms to produce a purified water.

18. A method and process of claim 1 wherein said purified water stream is pump to at least two stationary holding tanks for final purification to produce a purified water product suitable for human consumption.

19. An apparatus that is a water purification device that comprises a method and a process network of functional systems constructed to remove harmful inorganic and organic substances present in lakes, ponds, rivers, oceans, streams, coal ash ponds, mining streams, mining production, industrial, chemical, and municipal wastewater discharges with said apparatus comprising:
A tank that stores the activator compound or activator solution;
A micro pump;
A device capable of transferring water, water-based mixtures, or aqueous solutions;
A device capable of measuring liquid flow rates;
A device capable of measuring pressure or pressure changes created by the flow of a liquid through a tube or pipe;
An “activator compound or activator solution” that is a metal chelator ligand compound;
A settling tank(s);
A high velocity centrifuge capable of creating a g-force sufficient to separate out residual heavy metal chelate ligand complexes and perfluoro alkyl hydrocarbons;
A 1^{st} stage filtration section suitable for removing debris and small particulate matter;
A 2^{nd} stage filtration section suitable for removing organic compounds, chlorine;
A 3^{rd} stage filtration section suitable for removing yeasts, fermented substances, and polyfluorinated hydrocarbons;
A 4^{th} stage filtration section suitable for removing residual perfluoroalkyl hydrocarbons, cryptosporidium, and viruses;
A 1^{st} stage purification treating tank;
A 2^{nd} stage purification treating tank;
A disinfected agent;
An oxidizing agent;
A skid mount designed to house said apparatus;
A stationary platform or base foundation to house said apparatus.

20. A method and process of claim 19 wherein said activator tank is a “storage tank” that can be fabricated from common industrial materials, preferably but not limited to stainless-steel, or fabricated from plastic, preferably but not limited to high density polyethylene. The storage tank is used to store the activator compound or activator solution. The storage tank could be attached to the skid frame of said apparatus. The storage tank could optionally be detached from the skid mount and used at a remote location.

21. A method and process of claim 19 wherein said water purification device has a transfer line network system located on said apparatus that carries water from one functional section of the said water purification device to another.

22. A method and a process of claim 19 wherein said micropump is a device that is a mechanical or digital instrument that is located on said apparatus water purification device wherein said micropump has an adjustable flow rate capacity and is capable of pumping or transferring said activator solution to the settling tank.

23. A method and a process of claim 19 wherein said flowmeter device is a mechanical or digital instrument that is located on said water purification device wherein the flowmeter is capable of measuring the flow of water through a transfer line network system located on apparatus that carries water from one functional section to another.

24. A method and a process of claim 19 wherein said pressure monitor device that is mechanical or digital, located on said apparatus water purification device wherein the pressure monitor device is capable of measuring changes in pressure that the flow of water may create as it passes through transfer line network systems located on said water purification device from on functional section to another.

25. A method and process of claim 19 wherein said “activator compound” is a metal chelator ligand compound. For the purpose of this invention the metal chelator ligand can be used as a solid or liquid to satisfy the utility of this invention. The said “activator compound” is selected from the group consisting of alpha lipoic acid, sodium lipoate, potassium lipoate, green tea extract (comprised of catechin, epicatechin, gallocatechin, epigallocatechin, epigallocatechin gallate), grape seed extract (comprised of monomers, oligomers, polymers of proanthocyanins), n-acetylcysteine, cysteine, L-arginine, alpha-ketoglutarate, glutamine, ethylenediaminetetraacetic acid, sodium ethylenediaminetetraacetic acid, calcium ethylenediaminetetraacetic acid, dimercaptosuccinic acid, ethylene diamine, tetraethylethylenediamine, tetramethylethylenediamine, and tetraethylene pentamine. The preferred metal chelator ligand compounds are L-arginine, and Sodium lipoate.

26. A method and process of claim 19 wherein the concentration of said activator compound to be used is sufficient to remove heavy metals/and or heavy metal substances and perfluoro alkyl hydrocarbons from water or aqueous mediums. The said chelate ligand compounds of the present invention interact with heavy metals and perfluoro alky hydrocarbon complexes in water and/or aqueous medium to create new complexes that have undesirable electrostatic and molecular weight characteristics and properties wherein such complexes exhibit limited water solubility making such complexes easy to remove from water or aqueous medium by gravity and/or chemical adsorption methods.

27. A method and a process of claim 19 wherein said activator compound can also be formulated as a “activator solution” (diluted solution), preferably an aqueous solution that comprises a water-soluble organic and/or inorganic metal chelator ligand solution or the salt of said metal ligand chelator formulated in water. The metal ligand chelator aqueous solution could be from 0.5% to 75%, and preferably from 1% to 25%.

28. A method and process of claim 27 wherein said activator compound's solution concentration is in the range of 2 to 25%. One aspect of the present method is the activator solution is 2% L-arginine in water. Another aspect of the method is that the activator solution is 5% potassium lipoate in water. Yet still, another aspect of the method and process is that the activator solution is 10% glutamine in water.

29. A method and process of claim 19 wherein the concentration of said activator compound to be used to effectively remove heavy metals/and or heavy metal substances is based on the molar concentration of said activator to metal. For example, molar ratios of 2:1, 3:1, or 4:1, with the final concentration of activator compound to be used being determined by the known molar concentration levels of heavy metals and perfluoroalkyl hydrocarbons in the water.

30. A method and process of claim 19 wherein said “activator compounds” can be used individually to chelate heavy metal/heavy metal substances and perfluoroalkyl hydrocarbons in water, or they can be mixed together. A blend of activators could be used at a ratio of 1:1, 1:2, or 2:1 depending upon the selected activators. One example of an activator blend would be a 1:1 ratio (molar basis) of alpha-ketoglutarate and n-acetylcysteine. Another blend could be a 1:1 ratio of L-glutamine and alpha-ketoglutarate. Still a further blend of activator compounds could be a 1:1 ratio of grape seed extract and potassium lipoate. The concentration use of the activator (s) is based on molar concentration of activator to metal, for example 2:1, 3:1, or 4:1, with the final concentration of activator compounds to be used being determined by the known molar concentration levels of heavy metals and perfluoroalkyl hydrocarbons in the water.

31. A method and process of claim 19 wherein said activator compound can chelate heavy metals such as, but not limited to iron, arsenic, lead, chromium, cadmium, cobalt, mercury, nickel, vanadium, copper, gold, platinum, silver, manganese, uranium, and the like. The treatment of water containing heavy metals with said activator compounds described herein causes such heavy metals to precipitate out of solution, whereas, said solution in most cases is an aqueous medium but not limited to thereof.

32. A method and a process of claim 19 wherein said activator solution is pumped from the activator tank into a settling tank(s) which has a volume capacity of, but not limited to 500 gallons to 100,000 gallons (which holds the contaminated heavy metal/perfluoroalkyl hydrocarbon water) by way of said micro pump located on skid mount. It is also an extension of the present invention that the activator solution could be added to the settling tank(s) by other means for example, a positive displacement pump. The activator solution could also be added into the settling tank(s) simply by manual addition from a container or by means of a syringe. The interaction of the activator with heavy metals and/or heavy metal inorganic or organic complexes causes such heavy metals to precipitate out of the water and the interaction of the activator compound with perfluoroalkyl hydrocarbons forms electrostatically water unstable perfluoroalkyl complexes making them easy to be removed from water by gravity methods or chemical adsorption.

33. A method and a process of claim 19 the (activator)-metal complex(s) is allowed to precipitate out of water in said settling tank(s) over a period of time from 0.5 hour to 120 hours, but preferably from 1 hour to 24 hours.

34. A method and a process of claim 19 wherein said liquid-solids, liquid-liquid, or liquid-liquid-solids high velocity centrifuge receives the reduced heavy metal water from said settling tank(s) by via a transfer line network system located on said apparatus. The liquid-solids, liquid-liquid, or liquid-liquid-solids high velocity centrifuge capable of producing a g-force from 1,500 g's to 30,000 g's. The 1,500 g's to 30,000 g's high velocity centrifuges are capable of separating water, oil/liquid hydrocarbons, and high molecular weight and/or substances with a density greater than 1.0 g/ml, with the higher g-forces resulted in more efficient and effective heavy metals removal. It is understood that residual heavy metal activator chelate substances will be captured as a bottoms/solids material in the solids bowel compartment.

35. A method and a process of claim 34 wherein said high velocity centrifuge could be but not limited to the GF75 Tubular Vertical Centrifuge for water-oil-solid separation. One aspect of the present invention is that the high velocity centrifuge would be a liquid-liquid-solids GF75 Tubular Vertical centrifuge which can create a g-force from 8,000 g's to 30,000 g's to separate water streams, oil streams, and heavy metals chelate substances. The GF75 Tubular Vertical Centrifuge will produce reduced-reduced heavy metal water at the water outline valve. The reduce-reduced heavy metal water exits the water outlet valve, the oil stream exits the oil outlet valve and may be pumped to an oil containment tank, and the heavy metal chelate substances are trapped in a bowl located at the bottom of the centrifuge. The high velocity centrifuge could have a bowel discharge that is manually or one that is continuous. The reduce-reduced heavy metal water exits the water outlet valve and is transferred via a transfer line network system located on said apparatus frame into the 1^{st} stage filtration section of said apparatus water purification device.

36. A method and a process of claim 19 wherein said 1^{st} stage filtration section is used to remove debris and small particulate matter that may have exited the high velocity centrifuge entrained with the reduced-reduced metal water stream. The 1^{st} stage filtration section could contain a synthetic cotton melt-down blown filters, a synthetic cotton pleaded sediment filters, a synthetic cotton string-wound sediment filters, or a synthetic cotton bag filters contained in a housing canister, or a suitable holding compartment.

37. A method and a process of claim 36 wherein said 1^{st} stage filters could be composed of a synthetic polyester material, synthetic hydrophobic sulphone material, or synthetic cotton polypropylene material. The preferred filter material for the Pt stage filtration section is a filter composed of spun multi-layer density polypropylene or polyester contained in the appropriate housing.

38. A method and a process of claim 37 wherein said 1^{st} stage filters synthetic filters are capable of removing particle substances that range in size from 100 microns to 5 microns, but preferably 5 microns at normal pressures.

39. A method and a process of claim 38 wherein the polypropylene or polyester filters in the 1^{st} stage filtration section is contained in a housing canister, or suitable container. The filter canister housing could be made out of a synthetic plastic or metal material, preferably, stainless-steel.

40. A method and a process of claim 19 wherein said 1^{st} stage filtration section could contain 1 to 50 polypropylene units (filter+housing canister), but preferably from 4 to 12 units. The desired number of polypropylene filter units will depend upon how much water needs to be processed on a daily basis.

41. A method and process of claim 40 wherein said 1^{st} stage filter housing canister has an inlet and outlet that allows the reduced-reduced metal water to enter the housing canisters, contact thoroughly the polypropylene filters, and an outlet on the housing canister allows the reduced-reduced metal water to exit being transferred via a transfer line network system located on said apparatus frame into the 2^{nd} stage filtration section.

42. A method and a process of claim 19 wherein said 2^{nd} stage filtration section contains a carbonaceous material and/or an activated carbon filtering material or filters contained in a housing canister, or suitable housing. The activated carbon filter materials can be manufactured either by the process of carbonization or activation. Thermal activation or chemical activation are means to produce the activated carbon filters used.

43. A method and a process of claim 42 wherein said carbonaceous material and/or an activated carbon filtering material could be made from but not limited to coconut shells, wood, paper, coal, charcoal, bamboo shoots, lignite, petroleum pitch, and peat. The activated carbon in the filter could be granular, extruded, powdered, or bonded powdered (polymer coated).

44. A method and a process of claim 43 wherein said carbonaceous material and/or activated carbon filtering material is to have an internal surface of 500 m²/g to 3500 m²/g. The activated carbon filter could have a micron rating from 1 micron to 50 micron, but preferably 1 micron to 10 micron, and most preferably 5-micron rating.

45. A method and process of claim 44 wherein said carbonaceous and/or activated carbon materials is suitable to remove trace heavy metals, organic amines, heavy and light mineral oils, polycyclic aromatic hydrocarbons, nonpolar hydrocarbons, polar hydrocarbons, chlorides, chlorine, Iodine, Fluorene, BETX, phenol, halogenated organic substances, water soluble metallo-complexes, yeasts, and various fermented substances.

46. A method and a process of claim 45 wherein the carbonaceous and/or activated carbon materials in the 2^{nd} stage filtration section is contained in a housing canister or a suitable housing container. The filter housing canister could be made out of a synthetic plastic or metal material, preferably, stainless-steel.

47. A method and a process of claim 19 wherein said 2^{nd} stage filtration section could contain 1 to 50 activated carbon filter units (filter+housing canister), but preferably could contain 4 to 12 units. The desired number of activated carbon filter units will depend upon how much water needs to be processed on a daily basis.

48. A method and process of claim 47 wherein said filter housing canister has an inlet and outlet that allows the reduced-reduced metal water to enter the housing canister, contact thoroughly the carbonaceous and/or activated filter, and an outlet on the housing canister allows the reduced-reduced metal water to exit being transferred via a transfer line network system located on said apparatus frame into the 3^{rd} stage filtration section.

49. A method and a process of claim 19 wherein said 3^{rd} stage filtration section contains a carbonaceous material and/or an activated carbon filtering material or filters contained in a housing canister, or suitable housing. The activated carbon filter materials can be manufactured either by the process of carbonization or activation. Thermal activation or chemical activation are means to produce the activated carbon filters used.

50. A method and a process of claim 49 wherein said activated carbon filter could be made from but not limited to coconut shells, wood, paper, coal, charcoal, bamboo shoots, lignite, petroleum pitch, and peat. The activated carbon in the filter could be granular, extruded, powdered, or bonded powdered (polymer coated).

51. A method and a process of claim 50 wherein said carbonaceous material and/or activated carbon filtering material should have an internal surface of 500 m²/g to 3500 m²/g. The activated carbon filter could have a micron rating from 0.1 micron to micron, but preferably 0.1 micron to 1.0 micron, and most preferably 0.3 micron rating.

52. A method and a process of claim 51 wherein said carbonaceous and/or activated carbon materials is suitable to remove trace heavy metals, organic amines, heavy and light mineral oils, polycyclic aromatic hydrocarbons, nonpolar hydrocarbons, polar hydrocarbons, chlorides, chlorine, Iodine, Fluorene, BETX, phenol, halogenated organic substances, water soluble metallo-complexes, perfluoroalkyl substances, yeasts, and various fermented substances.

53. A method and a process of claim 52 wherein the carbonaceous and/or activated carbon materials in the 3^{rd} stage filtration section is contained in a housing canister or a suitable housing container. The filter housing canister could be made out of a synthetic plastic or a metal material, preferably stainless-steel.

54. A method and a process of claim 19 wherein said 3r d stage filtration section could contain 1 to 50 activated carbon filter units (filter+housing canister), but preferably could contain 4 to 12 units. The desired number of activated carbon filter units will depend upon how much water needs to be process on a daily basis.

55. A method and process of claim 54 wherein said filter housing canister has an inlet and outlet that allows the reduced-reduced metal water to enter the housing canister, contact thoroughly the carbonaceous and/or activated filter, and an outlet on the housing canister allows the reduced-reduced metal water to exit, being transferred via a transfer line network system located on said apparatus into the 4^{th} stage filtration section.

56. A method and a process of claim 19 wherein said 4^{th} stage filtration section contains ultrafiltration membrane filter membranes (UF) contained in a filtering housing canister or suitable housing. The UF filter membranes could be either in the form of flat sheet element, a spiral wound element or a tubular element known as a hollow fiber.

57. A method and a process of claim 56 wherein said ultrafiltration membrane filter (UF) could be composed of polylactic acid, ceramics, cellulose acetate, polypropylene, polysulfone, polyvinylidene fluoride, polyether sulfone, cellulose esters, and polyacrylonitrile.

58. A method and a process of claim 57 wherein said ultrafiltration membrane filter (UF) could have pores sizes that range from 0.001 micron to 0.1 micron, but preferably 0.001 micron to 0.01 micron. The UF membrane filters can be manufactured by a process called phase inversion.

59. A method and a process of claim 58 wherein said ultrafiltration membrane filters (UF) find suitable use to remove bacteria, protozoans, viruses, benzene, chlorine, proteins, pesticides, herbicides, perfluoroalkyl hydrocarbons, and cryptosporidium.

60. A method and a process of claim 19 wherein 4^{th} stage filtration section could contain 1 to 50 UF membrane filter units (filter+housing canisters), but preferably could contain 4 to 20 units. The desired number of UF membranes filter units will depend upon how much water needs to be process on a daily basis.

61. A method and process of claim 56 wherein said filter housing canister or a suitable housing container has an inlet and outlet that allows the reduced-reduced metal water to enter the housing canister, contact thoroughly the ultrafiltration membrane filter, and an outlet on the housing canister allows now “purified water” to exit, being transferred via a transfer line network system located on said apparatus into the 1^{st} stage purification tank (1).

62. A method and a process of claim 19 wherein said 1^{st} stage purification tank (1) receives said purified water via a transfer line network system located on said apparatus.

63. A method and a process of claim 19 wherein a said disinfectant agent is used to treat the purified water in said 1^{st} stage purification tank (1) includes but is not limited to hypochlorous acid, sodium hypochlorite, potassium hypochlorite, calcium hypochlorite, magnesium hypochlorite, or acetic acid.

64. A method and a process of claim 19 wherein said disinfectant agent solution could contain from 1% to 10% disinfectant agent but more preferably the disinfectant agent will contain 4% to 8% of the disinfectant material. Preferably, the disinfectant agent is sodium hypochlorite.

65. A method and a process of claim 65 wherein said sodium hypochlorite concentration in the purified water in the 1^{st} stage purification section could range from 1 mg/L to 50 mg/L, but more preferably 3 mg/L to 8 mg/L. The purified water is allowed to set in 1^{st} stage purification tank from 15 minutes to 24 hours, but preferably 1 hour to 5 hours.

66. A method and a process of claim 19 wherein said 2n d stage purification tank (2)) receives said purified water from the 1^{st} stage purification tank (1) via a transfer line network system located on said apparatus.

67. A method and a process of claim 19 wherein said an oxidizing agent is used to decompose residual disinfectant agent in the 2^{nd} stage purification tank (2) is an aqueous solution of hydrogen peroxide an aqueous solution of boric acid, and an aqueous solution of borax. Preferably, the oxidizing agent is hydrogen peroxide.

68. A method and a process of claim 63 wherein said oxidizing agent in solution could have a concentration of 1 to 20% but preferably, 1 to 8% in water. Preferably, the oxidizing solution is 1% to 5% hydrogen peroxide in water.

69. A method and a process of claim 63 wherein a sufficient amount of said hydrogen peroxide is used to eliminate excessive chlorine in the purified water in the 2^{nd} stage purification tank (2) and to ensure that the final water product meets the EPA levels for chlorine of 4 mg/L or less.

70. A method and a process of claim 19 wherein said a skid mount designed to house said apparatus.

71. A method and a process of claim 19 wherein a stationary platform or base foundation is used to house said apparatus.
